(19) United States
(12) Patent Application Publication
(10) Pub. No.: US 2008/0066183 A1
(43) Pub. Date: Mar. 13, 2008

(54) Master device for manually enabling and disabling read and write protection to parts of a storage disk or disks for users

(76) Inventors: George Madathilparambil George, Bangalore (IN); Nikhil George, Bangalore (IN)

Correspondence Address: GEORGE MADAT-H-ILPARAMBIL GEORGE, 307, VAYU, MY HOME NAVADWEEPA, MADHAPUR, HYDERABAD, 500081, omitted

(21) Appl. No.: 11/519,178

(22) Filed: Sep. 12, 2006

(51) Int. Cl. H04L 9/32

(52) U.S. Cl. 726/27

(57) ABSTRACT

Data protection is weak with the methods currently available and there are risks of corrupting important data, including system data accidentally by users or by malicious programs. We are proposing a method for improving access protection, more particularly, protection for data on mass memories by adding a hardware that will enable or disable read or write protection to portions of mass memories for each user. The hardware supports one or more users and two or more states for each supported user. The state of the hardware is manually controlled by the users. Depending on the configuration, each hardware state corresponding to a user corresponds to disabling or enabling read or write protection to some portions of a mass memory or mass memories for that user.

### BACKGROUND OF THE INVENTION

The present invention relates to controlling access for users to portions of mass memories such as hard disks, storage arrays, JBODs (Just a Bunch of Disks), RAID storage or future technologies for mass memories. We also use the word storage to refer to mass memories in this invention.

Current technologies provide protection at the file system level and a malicious program or user can get access as a privileged user and read confidential user data or corrupt user data. It requires hardware support to gain complete protection from malicious programs. Prior art technologies allow either full access or one level of hardware controlled restricted access. This level of hardware support is not sufficient to protect all users. It is possible for privileged users to corrupt data unintentionally by installing a malicious program or by manual error during full access.

We refer to the software, firmware and hardware components that control access to mass memories as storage components. The storage components are file systems, volume managers, storage stack, interface drivers, Host Bus Adapters, disk controllers, etc. File systems create a logical view of data in the form of files and directories. Some systems contain volume managers which present logical disks to its upper layer modules such as file systems. The storage stack provides access to physical disks for file systems, volume managers and users who do read or write directly to disks (raw access). Interface drivers control Host Bus Adapters (HBAs) and provide an interface for the storage stack to issue storage commands and transfer data from and to the storage. On systems that do not have a storage stack, file systems interact directly with interface drivers. The Host Bus Adapters are connected to storage array controllers or disk controllers through an interconnect mechanism such as SCSI, SAS, SATA, FC, IDE, etc. A firmware on a disk controller or the disk controller hardware controls operations on the disk in response to commands received from Host Bus Adapters. A firmware on the storage array controller or the storage array controller hardware controls operations on the array in response to commands received from Host Bus Adapters.

There are different methods for access control such as non-privileged users in UNIX or Windows operating systems who cannot access all parts of mass memories (storage). But a malicious program or user can sometimes exploit security weaknesses in an operating system, to get access as a privileged user. This will allow malicious users to gain access to critical data belonging to other users or corrupt users' data.

There is serious risk to users' data when their laptops are stolen or when someone gains access to a user's computer in the user's absence.

There is serious risk to users' data when a privileged user is malicious.

There are many methods for protecting user memories which do not require manual action for enabling and disabling protection; Such protections can be compromised by malicious programs by emulating the required software behavior.

U.S. Pat. No. 6,330,648 illustrates a method of adding protection against malicious programs using a manually controlled hardware with two states. By default the protection is enabled and has a mechanism to manually switch off the protection. This invention will not be able to provide protection for portions of storage belonging to each user, as is possible using our invention. In addition, manual action can enable only one hardware. So for a system administrator who wants to install a software update on a large number of machines in a data center, the solution provided by this invention is very cumbersome and requires the system administrator to manually disable protection for each computer the administrator needs to update. Another drawback of the invention is that the solution cannot be used with mass memories which are already manufactured.

US Patent application 20060117156 illustrates a method of adding protection for non-volatile memories against malicious programs using a manually controlled hardware with two or more states, but only two states are used for protection. One state has protection enabled and other state has protection disabled. This invention will not be able to provide protection for portions of storage belonging to each user, as is possible using our invention. In addition, manual action can enable only one hardware. So for a system administrator who wants to install a software update on a large number of machines in a data center, the solution provided by this invention is very cumbersome and requires the system administrator to manually disable protection for each computer the administrator needs to update.

FIG. 1 shows an example of storage components that allow a process in a computer to connect to mass memories such as hard disks, storage arrays, etc. The computer 101 has an internal disk 102. The computer 101 is connected to an external disk 103, a storage array 104 and a JBOD (Just a Bunch Of Disks) 105. The user processes running on the computer interact with File System 106, Volume Manager 107, or the storage stack 108. File systems 106 interact with Volume Managers 107 and Storage Stack 108. The Volume Manager 107 interacts with Storage Stack 108. The storage stack sends disk read or disk write requests to Host Bus Adapter (HBA) through Interface Drivers 109, 110. The Interface Drivers control Host Bus Adapters (HBAs) 111, 112, 113, 114. The HBAs are connected to disk or array controllers through storage interconnects such as SCSI bus, SAS, SATA or FibreChannel network. In this example, HBA#1 111 is connected to Disk Controller 115, HBA#2 112 is connected to Disk Controller 116, HBA#3 113 is connected to Array Controller 117 and HBA#4 114 is connected to Disk Controller 118 in the JBOD 105.

Disk controllers control operations of the disk or disks connected to them. Disk firmware controls operations of disk controllers. Array controllers control operations of disk controllers in arrays. Array controller firmware controls operations of array controllers.

A computer may have one or more file systems. Some computers do not contain volume managers. Some computers may contain one or more volume managers. Some computers do not contain a storage stack.

### BRIEF SUMMARY OF THE INVENTION

Mass memories include hard disk drives, storage arrays, JBODs, RAID storage, etc. It is the object of the present invention to use a slave hardware which supports one or more users and supports two or more states for each user to control access to portions of mass memories to which a user has access. We refer to this hardware as Slave Disk User Protection Hardware or SDUPHardware. It requires a manual action on a master device to change the state of the SDUPHardware corresponding to each user. We refer to the master device on which manual action is done as Disk User Protection Master Device or DUPMasterDevice. We refer to the manual action on the DUPMasterDevice to change the state corresponding to a user on the SDUPHardware as DUPManualAction.

According to the invention, the software, firmware and hardware that implement access restrictions, check the current state of the SDUPHardware and fail each read or write operation which do not meet the access restrictions permitted by the current state of the SDUPHardware corresponding to the user on whose behalf the read or write operation is initiated.

Privileged users provide users access to portions of mass memories. The configuration containing access restrictions for each user is written to an area of a mass memory to which only the privileged users have access. This area of the mass memory is protected by the SDUPHardware.

According to the invention, a configuration software allows a user or privileged users to further divide the portions of mass memory or memories to which the user has access and associate each state of the SDUPHardware corresponding to a user with disabling or enabling write or read access to portions of mass memory or memories. Preferably, only a user is allowed to configure access restrictions for himself or herself to portions of mass memory or memories to which that user has been given access by a privileged user or privileged users or the operating system.

The configuration software configures one or more storage components and/or new modules to disable or enable read or write access for a user to portions of a mass memory or memories depending on the state of the SDUPHardware corresponding to a user.

If storage components other than the file systems implement access restrictions, the file systems need to tag a read or write operation with the identifier of the current user of a buffer in the file system buffer cache. Other storage components may not be able identify the user on whose behalf a read or write request is initiated, without this tag. If more than one user is using a buffer in buffer cache in a file system, the accesses by different users need to be serialized so that there is only one user for a buffer at any point of time. Since only one user is associated with a buffer at any time, read or write requests can be tagged with the identifier of that user. The buffer in the buffer cache is written (flushed) to the mass memory (non-volatile storage) if it is dirty (a buffer becomes dirty when a user writes to the buffer), before the buffer is assigned to another user.

If storage components other than the file systems implement access restrictions, the SDUPHardware is not allowed to change the state corresponding to a user until all dirty buffers corresponding to the user are written to mass memory or memories.

The DUPManualAction on a DUPMasterDevice may be pressing one or more buttons and/or toggling the position of one or more switches and/or turning a wheel and/or changing one or more jumper positions and/or any other manual action accepted by the DUPMasterDevice.

The DUPManualAction causes the DUPMasterDevice to authenticate the user who initiated the DUPManualAction.

A DUPMasterDevice may control one or more SDUPHardwares.

Preferably, each user has his or her own DUPMasterDevice to change the state corresponding to himself or herself.

Some SDUPHardwares can be configured to change to the same state corresponding to a user at the same time. Preferably, the SDUPHardwares synchronize with the DUPMasterDevice so that SDUPHardwares can change to the same state corresponding to a user at the same time.

### BRIEF DESCRIPTION OF THE SEVERAL VIEWS OF THE DRAWINGS

FIG. 1 illustrates different components of the storage system on a computer.

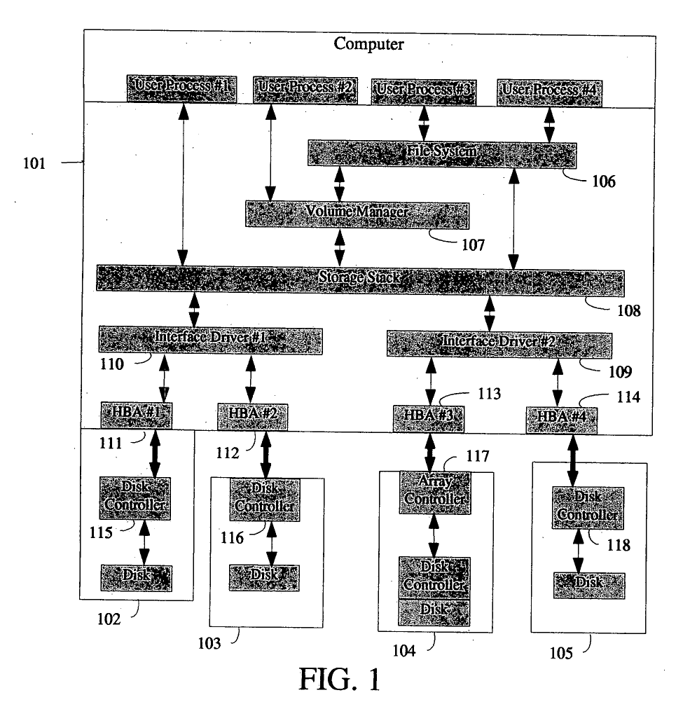

FIG. 2 illustrates an example for states of a DUPMasterDevice that accept DUPManualAction for changing the state corresponding to a user and sends state change master commands to one or more SDUPHardwares.

FIG. 3 illustrates an example for states of a SDUPHardware that accepts master commands from a DUPMasterDevice.

FIG. 4 illustrates an example for states of a device driver that controls the SDUPHardware and a file system module which flushes dirty buffers of a user in the file system buffer cache to mass memory and removes the association between the user and the buffers in the buffer cache, before sending a message containing the identifier of the user to the SDUPHardware device driver.

FIG. 5 illustrates an example for states of a module in the storage component that implements access restrictions for each user.

FIG. 6 illustrates an example for states of a DUPMasterDevice that allows SDUPHardwares to synchronize state changes corresponding to users.

FIG. 7 illustrates an example for states of a SDUPHardware that is configured to synchronize state changes with one or more SDUPHardwares and synchronization is achieved by communicating with the DUPMasterDevice which controls these SDUPHardwares.

FIG. 8 illustrates an example of how different components interact when used with a DUPMasterDevice that accepts DUPManualActions.

### DETAILED DESCRIPTION OF THE INVENTION

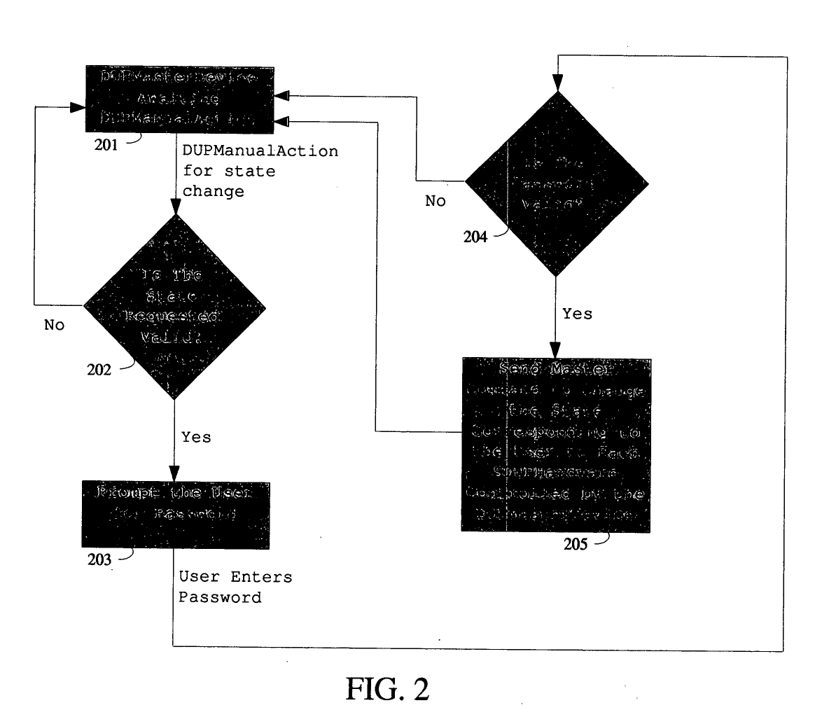

FIG. 2 illustrates an example for different states of a DUPMasterDevice that controls one or more SDUPHardwares and accepts DUPManualAction to change the state corresponding to a user. The DUPMasterDevice awaits 201 DUPManualAction from its user to change the state of the SDUPHardware/s controlled by that DUPMasterDevice corresponding to the user. When the user performs the DUPManualAction, the DUPMasterDevice checks 202 whether the state requested by the user is valid. If the state requested is invalid, the DUPMasterDevice ignores (discards) the DUPManualAction. If the state requested is valid, the user is prompted 203 for a password. If the password entered by the user is invalid 204, the DUPMasterDevice ignores (discards) the DUPManualAction. If the password entered by the user is valid 205, the DUPMasterDevice establishes connection and sends a master command to change the state corresponding to the user, to each SDUPHardware it controls.

Some DUPMasterDevices may allow both the user and the state to be selected through DUPManualAction.

Preferably, there should be one DUPMasterDevice for each user and in this case the manual action to select a user could be avoided. In this case, the DUPManualAction involves only selecting the state for the user of the DUPMasterDevice. This kind of a DUPMasterDevice is shown in FIG. 2.

The DUPManualAction on a DUPMasterDevice may be pressing one or more buttons and/or toggling the position of one or more switches and/or turning a wheel and/or changing one or more jumper positions and/or any other DUPManualAction supported by the DUPMasterDevice.

There could be different behaviors for the DUPMasterDevice while accepting passwords. If the password entered by a user is invalid, the SDUPHardware could again prompt the user for a password and accept a new password from the user until a valid password is received or until the maximum number of password retries is reached or if the user cancels the request to reenter the password. The DUPMasterDevice that supports password retries, will ignore (discard) a DUPManualAction only if a valid password is not received even after the maximum number of password retries or if the user cancels the password retry. The DUPMasterDevice may also prompt for a user name in addition to the password. The DUPMasterDevice may also prompt for a password before the state entered by the user is validated. The method used by a DUPMasterDevice for authenticating a user using a password is implementation specific.

The DUPMasterDevice may use other options for validating a user, such as finger print validation, retina validation, other current and future technologies for user authentication. The DUPMasterDevice may also use a combination of two or more of password validation, finger print validation, retina validation, etc., for authenticating the user. The authentication may be done before or after validating the state requested. The method used by a SDUPHardware for authenticating a user is implementation specific.

There are different options for communication between a DUPMasterDevice and each SDUPHardware it controls. One option is to establish a logical connection and send a command. If the connection could not be established, the DUPMasterDevice may retry the connection until the maximum number of retries expires. Another option is to send a connectionless command to each SDUPHardware and await confirmation from each SDUPHardware. The DUPMasterDevice in this case should keep track of which SDUPHardware sent the confirmation and resend the connectionless command to each SDUPHardware that has not responded until retry count expires. A third option is to use a master broadcast or multicast command to all SDUPHardware which are controlled by a DUPMasterDevice. Some of these options can also be used for other types of communications between SDUPHardware and DUPMasterDevice. The method used for communication between a DUPMasterDevice and a SDUPHardware is implementation specific.

Each DUPMasterDevice may control states of a set of SDUPHardware where the sets need not be mutually exclusive and could be different. For example, a DUPMasterDevice belonging a system administrator may control all SDUPHardwares in a data center. The DUPMasterDevice belonging to a user of the data center could be a subset of all SDUPHardwares in the data center. The SDUPHardwares controlled by a DUPMasterDevice could be attached to different computers, storage arrays, JBODs etc. The SDUPHardware attached to a computer and the SDUPHardware attached to storage attached to the computer must change to the same state corresponding to a user at the same time, after synchronizing with one of the DUPMasterDevices that control them. SDUPHardware attached to different computers may change state independent of each other even when they are controlled by the same DUPMasterDevice. When a storage device is shared between two or more computers, it is recommended that the SDUPHardware on these computers and the SDUPHardware on the shared storage, must change to the same state corresponding to a user of the storage, at the same time, after synchronizing with one of the DUPMasterDevices that control them. The DUPMasterDevice configures SDUPHardwares that needs synchronization to initiate SDUPHardware synchronization before changing the state. The DUPMasterDevice also keeps track of the list of SDUPHardwares that must synchronize for changing the state corresponding to each user. The method used for synchronizing different SDUPHardware so that they change to the same state at the same time is implementation specific.

Preferably, a DUPMasterDevice and the SDUPHardwares controlled by it must use strong encryption for all communication. Preferably, a different encryption key should be used for different blocks of time. The encryption technology, time period for which a key is valid, etc., are implementation specific.

Preferably, a DUPMasterDevice and the SDUPHardwares controlled by it communicates using wireless communication.

Optionally, a DUPMasterDevice may be connected to one or more SDUPHardwares it controls through a wired connection. In this case, the DUPMasterDevice and the SDUPHardware which have wired connection may use wired communication and not wireless communication.

Optionally, a DUPMasterDevice and the SDUPHardwares controlled by it communicates using wired communication.

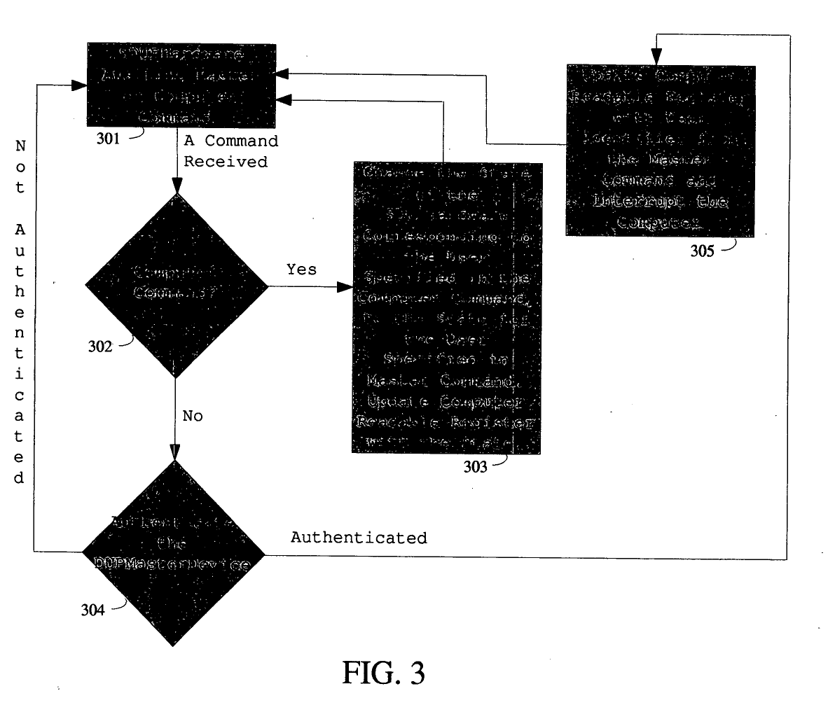

FIG. 3 illustrates an example for different states of a SDUPHardware that is attached to a computer and accepts master commands from one or more DUPMasterDevices. The SDUPHardware in this example need not synchronize with other SDUPHardwares for state change for users. The SDUPHardware awaits 301 either a master command from one of the DUPMasterDevices that control it or a command from the computer to which it is attached. The SDUPHardware checks 302 the type of input, a master or a computer command. When a master command is received, the SDUPHardware authenticates 304 the device that sent the master command. If the authentication fails, the master command is ignored (discarded). If the authentication is successful, the SDUPHardware updates 305 a register readable by the computer, with the identifier of the user in the master command and interrupts 305 the computer using a hardware interrupt, such as PCI interrupt. The computer cannot write into the SDUPHardware register containing the identifier of the user. The SDUPHardware then returns to the state where it waits for a master or a computer command. When the SDUPHardware receives a computer command 303 to change the state of the SDUPHardware corresponding to a user, the SDUPHardware changes the state of the user to the state contained in the master command for the user. Since the state requested by the user is not communicated to the computer, no malicious software can control the state of the SDUPHardware corresponding to a user. The SDUPHardware updates a register readable by the computer 303, with the state corresponding to the user. The computer cannot write into the register containing the state of the SDUPHardware corresponding to a user.

Preferably, if more than one master command is received for the same user before the state corresponding to the user is changed, the SDUPHardware will change state corresponding to that user to the state contained in the last authenticated master command for that user. Optionally, if more than one master command is received for the same user before the state corresponding to that user is changed, the SDUPHardware will change the state corresponding to that user to the state contained in the first authenticated master command for that user after the last state change for that user. Some implementations may even change the state to the state contained in one of the authenticated master commands between the first authenticated master command after the last state change and the last authenticated master command for that user, depending on some other criteria.

The SDUPHardware may use registers or memory locations readable by the computer to communicate the identifier of the user whose identifier is contained in the master command and the current state of SDUPHardware corresponding to a user. A computer should not be allowed to write into these registers or memory locations. This improves security as a malicious software will not be able to manipulate the state of the SDUPHardware corresponding to each user.

A SDUPHardware may control one or more mass memories. There could be one or more SDUPHardwares on a computer, each controlling states corresponding to a mutually exclusive set of users. Some implementations may use more than one SDUPHardware on the same computer, each controlling states corresponding to sets of users which are not mutually exclusive, but we do not recommend such implementations.

One or more DUPMasterDevices may control a SDUPHardware. If each user has a DUPMasterDevice, preferably, the state corresponding to each user controlled by a different DUPMasterDevice.

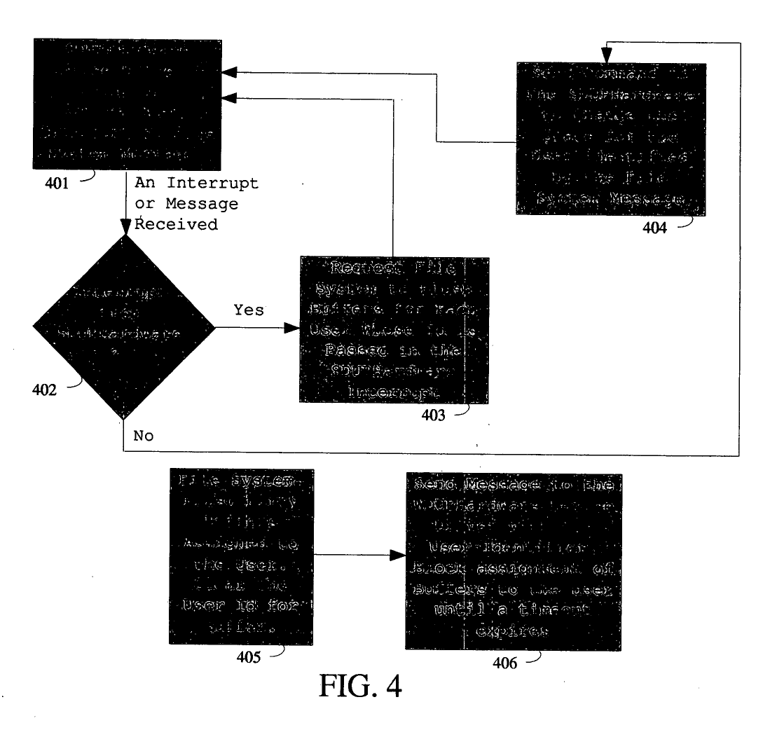

FIG. 4 illustrates an example for states of a device driver which runs on a computer and controls the SDUPHardware which accepts master commands. The SDUPHardware device driver runs 401 either when an interrupt from the SDUPHardware or a message from the file system arrives. The SDUPHardware device driver checks 402 the type of input, an interrupt or a file system message. When an interrupt is received 403, the driver sends a request to the file system to flush dirty buffers assigned to the user/s whose identifier/s are present in the computer readable user registers. Only the identifiers of the users who performed DUPManualActions on the DUPMasterDevice controlling the SDUPHardware, will be present in the computer readable user registers of the SDUPHardware. A buffer in the file system buffer cache is considered dirty if the user has written into the buffer. The file system flushes (writes to mass memories) 405 the dirty buffers assigned to the user in the file system buffer cache, resets the user identifier in all the buffers that were assigned to the user and then, sends a message 406 containing the user identifier, to the SDUPHardware device driver. The assignment of buffers in the file system buffer cache is delayed until a timeout expires. When the file system message is received, the SDUPHardware device driver sends 404 a command to the SDUPHardware to change the state corresponding to the user.

If there are more than one file systems on a computer, the SDUPHardware device driver must send messages containing the identifier of the user to all the file systems on the computer. The SDUPHardware device driver will command the SDUPHardware to change the state corresponding to a user only after all the file systems flush dirty buffers assigned to the user and reset the user identifier in all the buffers that were assigned to the user.

A SDUPHardware device driver may use one message for each user to request a file system to flush buffers corresponding to the user.

A SDUPHardware device driver may control one or more SDUPHardwares. There could be one or more SDUPHardware device drivers running on a computer, each controlling a mutually exclusive set of SDUPHardware.

There could be one or more storage components or new modules that implement access control according to the invention on a computer. We refer to the modules that implement access control according to the invention as DUPImplementers. When an upper layer module sends a new read or write request to a DUPImplementer, the DUPImplementer will get the current SDUPHardware state corresponding to the user on whose behalf the read or write request was created. The DUPImplementer is configured with information on portions of mass memories and type of access (read or write) allowed or denied for each portion of mass memory, for each combination of user and state. The DUPImplementer checks the portions of mass memory or mass memories accessed by the read or write request against the configuration. If a read or write requests violates the access restrictions, the read or write request is not allowed to proceed and is returned with error. If no configuration is present for a portion of mass memory, DUPImplementers are configured either to allow or to block the read or write request that accesses such a portion.

There are different ways to ensure that no buffers are assigned to the user after the file system sends a message to the SDUPHardware device driver, until the state changes. One option is to use a timeout. Another option is to configure the SDUPHardware to generate an interrupt when the SDUPHardware state corresponding to a user changes. A better option is to use both the timeout and the interrupt for state change.

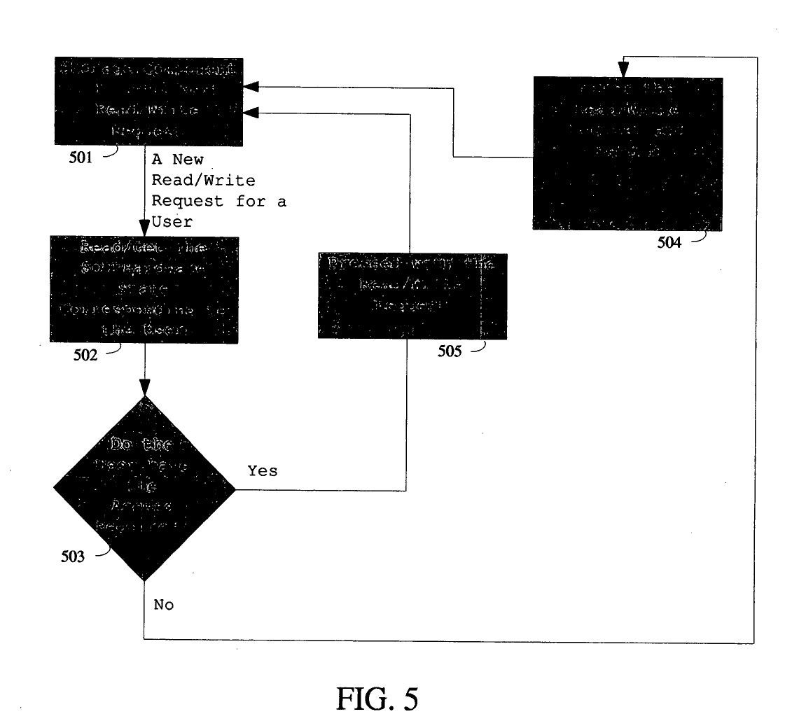

FIG. 5 illustrates an example for a storage component that is a DUPImplementer. The storage component processes read or write requests 501. When a new read or write request arrives, the storage component will read or get the SDUPHardware state 502 corresponding to the user on whose behalf the read or write request was created. The storage component checks 503 whether the read or write request violates access restrictions configured corresponding to the current state of the user. If access is not allowed 504, the read or write request is returned to the upper layer with an error. If the access is allowed 505 the read or write request is allowed to proceed.

A user is allowed access to portions of a mass memory or memories by privileged users. The portions of mass memories to which each user has access is not mutually exclusive. The portions of mass memories to which a user has access and the type of access is written to a portion of the mass memory to which only privileged users have access. The area of the mass memory where this configuration is stored is protected by the SDUPHardware.

A configuration software allows each user to further divide these portions of mass memory or mass memories to which the user has access. The configuration software further allows a user to enable or disable read or write access to each of these divided portions and associate the access restrictions to a state of the SDUPHardware corresponding to the user. Preferably, the access restrictions associated with each state is independent of access restrictions associated with other states of the SDUPHardware corresponding to the same user. Optionally, access restrictions are such that there are dependencies between access restrictions corresponding to some or all of the states corresponding to a user.

Preferably, the configuration corresponding to a user is written to a predefined area of the mass memory or mass memories, selected on the basis of the user identifier and write to this area is enabled for the user only on one or more states of SDUPHardware corresponding to the user. Preferably, no other users, including privileged users have write or read access to this area of the mass memory or mass memories.

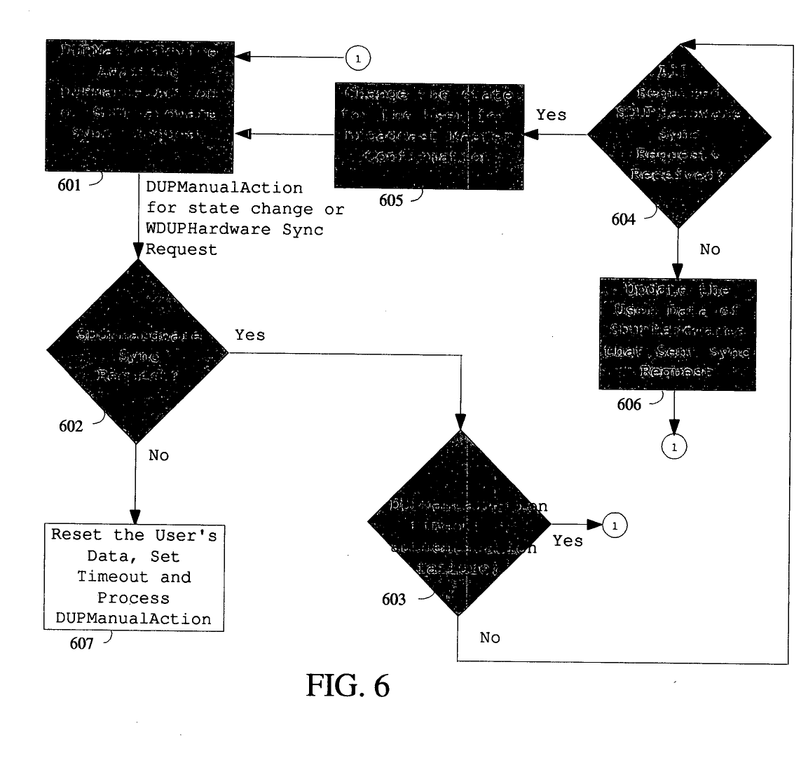

FIG. 6 illustrates an example of a state machine for a DUPMasterDevice which accepts DUPManualAction and also synchronizes state changes of two or more SDUPHardwares controlled by it. The DUPMasterDevice awaits 601 either a DUPManualAction or a SDUPHardware synchronization request from one of the SDUPHardwares controlled by it. The DUPMasterDevice checks the type of input, 602 DUPManualAction or SDUPHardware synchronization request. When a DUPManualAction is received 607 for a user, the DUPMasterDevice resets the user's data corresponding to the SDUPHardware synchronization requests already received, sets a timeout for receiving all SDUPHardware synchronization requests and processes the DUPManualAction. The state machine required for processing the DUPManualAction by a DUPMasterDevice is discussed in FIG. 2. When a SDUPHardware synchronization request is received, the SDUPHardware sending the synchronization request is authenticated 603. If the authentication fails the SDUPHardware synchronization request is discarded. If the authentication is successful, DUPMasterDevice checks whether the DUPManualAction has timed out. If the DUPManualAction has timed out, the SDUPHardware synchronization request is discarded. If the DUPManualAction has not timed out, the DUPMasterDevice checks whether all the SDUPHardware which are to be synchronized for the state change corresponding to the user, have sent SDUPHardware synchronization requests 604. If all the SDUPHardware synchronization requests are not received 606, the user's data structures are updated to show that the SDUPHardware has sent a SDUPHardware synchronization request for the user who initiated the DUPManualAction. If all the required SDUPHardware synchronization requests are received, the state of the user is updated 605 in the DUPMasterDevice. The DUPMasterDevice communicates the states of all users whose state changes must be synchronized, to all the SDUPHardwares controlled by it using repeated broadcast/multicast master confirmations (not shown).

Preferably, the user authentication is done as soon as a user performs DUPManualAction before reseting data structures or setting a timeout for receiving SDUPHardware synchronization requests.

Optionally, a device different from a DUPMasterDevice could be used for the SDUPHardware synchronization though this is not recommended. The exact mechanism used for synchronization is implementation specific.

Preferably, there should be an option for users to set timeouts for DUPManualActions.

Preferably, the broadcast/multicast master confirmation is sent a finite number of times after the last state change for a user.

Optionally, the DUPMasterDevice may use a unicast connection oriented or unicast connectionless communication instead of broadcast or multicast communication for communicating master confirmations. The exact mechanism used for synchronization is implementation specific.

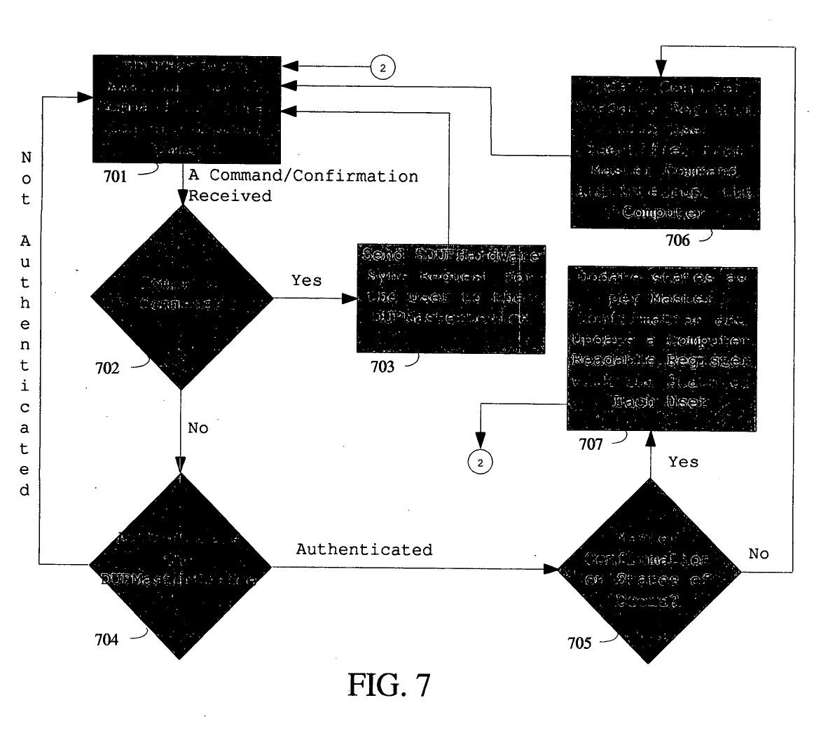

FIG. 7 illustrates an example for a state machine for a SDUPHardware that synchronizes state changes of each user with the DUPMasterDevice that sent the master command for state change. The SDUPHardware awaits 701 a master command to change the state corresponding to a user, or a broadcast master confirmation containing current states of users, or a computer command. The SDUPHardware checks 702 the type of input, master command/confirmation or a command from the computer. When a master command/confirmation is received, the SDUPHardware authenticates 704 the device that sent the master command/confirmation. If the authentication fails, the master command/confirmation is discarded. If the authentication is successful 705, the SDUPHardware checks the type of master input, a master command for state change for a user or a master confirmation for state change. If the master input is the master command for state change for a user 706, the SDUPHardware updates a register readable by the computer with the identifier of the user who performed the DUPManualAction and interrupts the computer. If the master input is a master confirmation 707, the state corresponding to each user for the SDUPHardware is updated to the state specified in the master confirmation. The SDUPHardware writes the state corresponding each user into a register readable by the computer. When the SDUPHardware receives a command from the computer 703 to change the state corresponding to a user, the SDUPHardware sends a SDUPHardware synchronization request containing the identifier of the user to the DUPMasterDevice which sent the master command for changing state of that user.

Preferably, the list of SDUPHardwares that must synchronize state changes for a user should be configurable using DUPMasterDevice. The DUPMasterDevice configures the SDUPHardwares to send a SDUPHardware synchronization request for a user when the computer connected to it sends a command to change the state corresponding to a user.

Optionally, a configuration software on a computer could be used to configure the lists of SDUPHardwares that must synchronize state changes for users.

Preferably, a DUPMasterDevice allows users to create lists of SDUPHardwares for themselves. The state corresponding to the user for SDUPHardwares in a list is independent of the state corresponding to the user for SDUPHardwares in other lists. A user can control the state corresponding to the user for SDUPHardwares in each list. Preferably, each list corresponds to SDUPHardwares that need to synchronize state changes between each other for the user. The master command and master confirmation sent by a DUPMasterDevice identifies the list or lists or list members and the SDUPHardwares ignores commands and confirmations for those lists in which it is not a member.

Optionally, though not recommended, a SDUPHardware can be configured to initiate state change synchronization only for some states corresponding to each user. For the rest of the states corresponding to a user, the SDUPHardware can change the state corresponding to the user as soon as a computer command for changing state corresponding to the user is received from the computer.

Preferably, only one DUPMasterDevice can control the state corresponding to a user for a given SDUPHardware at any given time.

Preferably, if more than one DUPMasterDevices are controlling the state corresponding to a user for a SDUPHardware, such DUPMasterDevices must communicate with each other to synchronize state changes for that user on that SDUPHardware and to send master confirmations of claim (25) for that user.

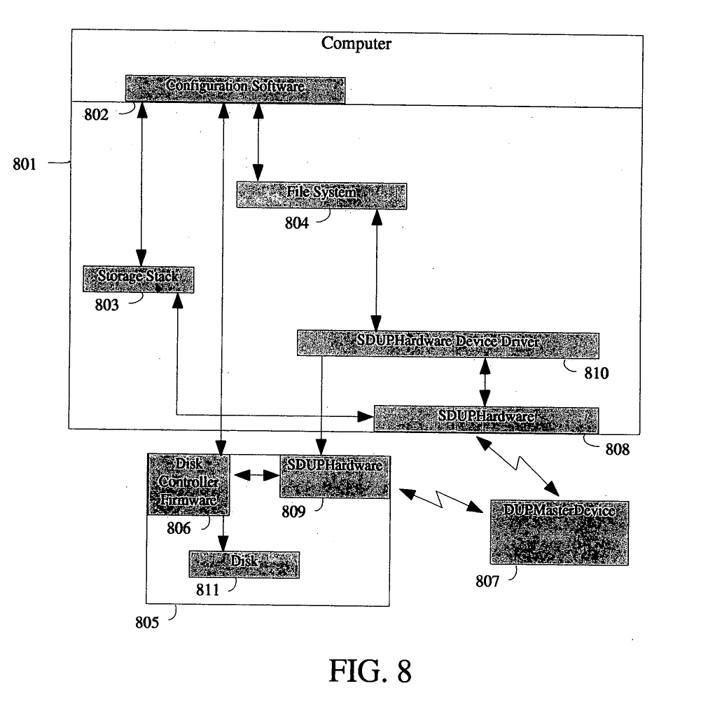

FIG. 8 illustrates an example of interaction between different components in a computer 801 that implement read and write protection for each user to parts of a mass memory, using SDUPHardwares 808 809 that accepts master commands. Only components that are changed or affected by the invention are shown. When a user performs a DUPManualAction on the DUPMasterDevice 807, the DUPMasterDevice authenticates the user. If the user is authenticated, the DUPMasterDevice sends a master command for state change to all the SDUPHardwares in the list selected by the user. The DUPManualAction involves selecting a list of SDUPHardwares and a state corresponding to the user. The SDUPHardware 808 which receives a master command authenticates the device that sent the command. If the authentication fails, the master command is discarded. If the authentication is successful and if the SDUPHardware is a member of the list selected by the user for state change, the SDUPHardware writes the identifier of the user in a memory location readable by the computer and interrupts the computer. The SDUPHardware device driver 810 processes the interrupt and reads the identifier of the user from the SDUPHardware. The SDUPHardware device driver sends a request to the file system 804 to flush dirty buffers assigned to the user. The file system 804 goes through the list of buffers assigned to the user, writes (flushes) dirty buffers that were assigned to the user to the mass memory and removes the association between the user and the buffer. After removing the association between the user and all the buffers that were assigned to the user, the file system 804 sends a message containing the identifier of the user to the SDUPHardware device driver 810. The SDUPHardware device driver sends a command to the SDUPHardwares 808 809 to change the state corresponding to the user. The SDUPHardware 809 is enclosed in a disk enclosure 805. The SDUPHardwares 808 809 send a SDUPHardware synchronization request to the DUPMasterDevice 807. The DUPMasterDevice authenticates the devices that sent SDUPHardware synchronization requests. After the authentication for both SDUPHardwares 808 809 are successful, the DUPMasterDevice updates the state corresponding to the user to the state requested by the user for the list of SDUPHardwares identified through the authenticated DUPManualAction. DUPMasterDevice sends a master confirmation containing the states corresponding to its user or users to all the SDUPHardwares controlled by it. The master confirmation will identify each user and state pair in the master confirmation with the SDUPHardwares that are expected to change state. The SDUPHardwares authenticate the device that sent the master confirmation. If the authentication is successful, for each user/state pair in the master confirmation, the state corresponding to that user is updated by each SDUPHardware if the SDUPHardware is identified for that state change. The SDUPHardware 808 writes the states into computer readable memory locations. The SDUPHardware 809 writes the states into disk controller firmware readable memory locations. In this example, the configuration software 802 configures the file system 804, the storage stack 803 and disk controller firmware 806 to implement access restrictions for users. The storage stack gets the state of the SDUPHardware corresponding to a user by reading the computer readable memory in the SDUPHardware 808 containing states. The file system gets the state of the SDUPHardware corresponding to a user through the SDUPHardware device driver, which reads the computer readable memory in the SDUPHardware 808 containing states. The disk controller firmware 806 gets the state of the SDUPHardware by reading a memory in the SDUPHardware 809 containing the current state for each user using an interface within the disk enclosure. The state of the SDUPHardware corresponding to a user is used by the storage stack, the disk controller firmware and the file system to implement access restrictions for the user configured using the configuration software. The configuration software interacts with the storage stack to write the configuration to the disk 811. The configuration is read by the storage stack, the disk controller firmware, the file system and the configuration software. The file system and the configuration software interact with the storage stack to read the configuration from the disk 811. The components which are not affected by the invention such as Interface Driver, HBA, Disk Controller, etc., are not shown.

The list of SDUPHardwares that must send SDUPHardware synchronization requests for a list may be a subset of SDUPHardwares that need to synchronize state changes for a user. For each computer, only one SDUPHardware connected to it needs to send the SDUPHardware synchronization request.

The protection provided by SDUPHardware need not be limited to mass memories alone. Other modules that implement access protections could check the current state of the SDUPHardware corresponding to a user and implement access restrictions based on the current state and the configuration associated with that state for the modules.

Since the SDUPHardware or part of the SDUPHardware can be enclosed in the same mass memory that is being protected, there is less risk to data even if the laptop of a user is stolen.

The authentication is done by DUPMasterDevice and a malicious software will not be able to manipulate the authentication process.

Since a DUPMasterDevice can control SDUPHardwares on different computers, a system administrator can change the state corresponding to himself or herself using one DUPManualAction on many SDUPHardwares attached to different computers. Hence a system administrator needs to do only one DUPManualAction to enable access for doing software updates on many computers.

What is claimed is:

1. A method for implementing access protection, more particularly for protecting user data on a mass memory or mass memories by
i) Using a slave hardware supporting one or more users and two or more states for each supported user; This hardware is referred to as Slave Disk User Protection Hardware or SDUPHardware.
ii) The state of the SDUPHardware corresponding to a user is controlled by manual action by that user on a master device; We refer to the master device on which the manual action is done as Disk User Protection Master Device or DUPMasterDevice; The manual action to change the state corresponding to a user on the DUPMasterDevice is referred to as DUPManualAction.
iii) The DUPMasterDevice authenticating the user who entered the DUPManualAction and optionally, validating the state requested by the user; The DUPMasterDevice rejecting the DUPManualAction if the authentication of the user or optional validation of the state fails;
iv) On receiving an authenticated DUPManualAction, the DUPMasterDevice sending a master command containing the identifier of the user who performed the DUPManualAction and the state requested for the user to the SDUPHardwares controlled by the DUPMasterDevice.
v) The SDUPHardware authenticating the device which sent the master command. The SDUPHardware rejecting the master command if the authentication fails.
vi) Preferably, when a master command is received and the device that sent the master command is authenticated, the SDUPHardware updating a computer readable memory location or a register with the identifier of the user who performed an authenticated DUPManualAction and interrupting the host computer;
vii) Preferably, a SDUPHardware device driver processing the interrupt and reading the identifier of the user who performed the DUPManualAction; Preferably, the SDUPHardware device driver sending a message containing the identifier of the user to the file systems; Where the SDUPHardware device driver is the software component that controls the SDUPHardware.
viii) Preferably, after file systems writing dirty buffers assigned to the user to the storage and removing association between the user and buffers that were assigned to the user, the SDUPHardware device driver allowing the SDUPHardware to change the state corresponding to the user to the state contained in the authenticated master command for the user; Where a buffer is dirty if a user has written to the buffer.
ix) Where the SDUPHardware is not configured to synchronize state change with other SDUPHardwares controlled by the DUPMasterDevice, the SDUPHardware changing the state corresponding to the user to the state contained in the last authenticated master command for the user received by the SDUPHardware.
x) Where the SDUPHardware is configured to synchronize state change with other SDUPHardwares controlled by the DUPMasterDevice, the SDUPHardware sending a SDUPHardware synchronization request to the DUPMasterDevice.
xi) The DUPMasterDevice authenticating the device that sent the SDUPHardware synchronization request; The DUPMasterDevice rejecting the SDUPHardware synchronization request if the authentication fails.
xii) After receiving authenticated SDUPHardware synchronization requests from all the SDUPHardwares to be synchronized for the requested state change for the user, the DUPMasterDevice changing the state corresponding to the user and communicating the states of its user or users to the SDUPHardwares which needed synchronization using master confirmations; Preferably, the master confirmation is a broadcast or multicast message. Preferably, the master confirmation will identify each user and state pair in the master confirmation with SDUPHardwares that are expected to change to the state for the user.
xiii) The SDUPHardware authenticating the device that sent the master confirmation broadcast or multicast message. The SDUPHardware rejecting the broadcast/multicast master confirmation if the authentication fails.
xiv) The SDUPHardware changing the state corresponding to a user after receiving an authenticated master confirmation to the state specified in the authenticated master confirmation if the SDUPHardware is identified for state change in the master confirmation.
xv) A user having access to one or more portions of a mass memory or mass memories;
xvi) The portions of a mass memory to which a user has access being further divided and access to these divided portions for the user being enabled only if the state of the SDUPHardware corresponding to the user allows such access;
xvii) A configuration software allowing a user or privileged users to associate one or more states of the SDUPHardware corresponding to a user with disabling or enabling write and/or read access to portions of one or more mass memories for that user;
xviii) The configuration software configuring one or more storage components and/or new modules to disable or enable read and/or write access for a user to portions of mass memory or mass memories depending on the state of the SDUPHardware corresponding to the user; The storage components being file systems, storage array controller firmware and hardware, disk controller firmware and hardware, storage stack, volume managers, Host Bus Adapter Interface drivers, Host Bus Adapter; A module that implements access protection based on the state of the SDUPHardware being referred to as DUPImplementer.
xix) Preferably, file systems tagging read or write requests to mass memories with the identifier of the current user of the buffer being written or read; Preferably, the access to each buffer in a file system buffer cache by different users are serialized and a dirty buffer is written to the storage before access is given to another user;
xx) Preferably, the operating system tagging each raw disk read or write request with the user identifier of the user issuing the raw disk read or write;
xxi) Optionally, read or write commands from the computer to a mass memory or mass memories being tagged with the identifier of the user on whose behalf the read or write is initiated;
xxii) A DUPImplementer using the identifier of the user in the read or write request and the current state of the SDUPHardware corresponding to the user to identify the parts of mass memory or mass memories to which access is restricted; The DUPImplementer comparing the part of mass memory or mass memories being accessed by the read or write request and the type of access, to the configured access restrictions. The storage components failing read or write requests which violate access restrictions.
xxiii) Preferably, there exists a SDUPHardware device driver that runs on the computer to which a SDUPHardware is connected and the SDUPHardware device driver controls the SDUPHardware.
xxiv) Preferably, a DUPMasterDevice and some of the SDUPHardwares controlled by the DUPMasterDevice communicate using wireless communication.

2. A method as claimed in (1), where the DUPManualAction on a DUPMasterDevice may be pressing one or more buttons and/or toggling the position of one or more switches and/or turning a wheel and/or changing one or more jumper positions and/or any other manual action accepted by the DUPMasterDevice.

3. The mechanism for authenticating a user who performed the DUPManualAction on a DUPMasterDevice of claim (1) may be based on finger print and/or retina and/or password and/or user name and/or other current or future technologies for user authentication.

4. A DUPMasterDevice as claimed in (1) controlling one or more SDUPHardwares; The SDUPHardwares controlled by a DUPMasterDevice may be connected to one or more computers and/or mass memories.

5. Preferably, the DUPMasterDevice and SDUPHardware of claim (1) using encryption for communication.

6. Optionally, some DUPMasterDevices and SDUPHardwares of claim (1) not using encryption for some or all communication.

7. Preferably, a DUPMasterDevice or SDUPHardware of claim (1) that receives a command or a message or a request of claim (1), authenticating the device which sent the command or message or request.

8. Optionally, some DUPMasterDevices or SDUPHardwares of claim (1) not authenticating all or some commands, and/or messages and/or requests.

9. Preferably, each user having a DUPMasterDevice of claim (1).

10. Preferably, more than one DUPMasterDevice of claim (1), optionally one DUPMasterDevice for each user, controlling the state of each SDUPHardware.

11. Preferably, a part of the SDUPHardware of claim (1) is enclosed in the same enclosure as the mass memory or mass memories which is/are being write or read protected by the SDUPHardware.

12. A SDUPHardware of claim (1), could be used to control the state of one or more mass memories.

13. A DUPMasterDevice and SDUPHardware of claim (1) may communicate to each other using unicast connection oriented and/or unicast connectionless and/or broadcast and/or multicast communication; Different communication options may be used for different types of commands, requests and messages.

14. Preferably, as claimed in (1), a DUPMasterDevice and the SDUPHardwares controlled by it communicate using wireless communication.

15. Optionally, a DUPMasterDevice of claim (1) may be connected to one or more SDUPHardwares it controls through a wired connection. In this case, the DUPMasterDevice and SDUPHardware which have wired connection may use wired communication. The DUPMasterDevice and the rest of the SDUPHardwares it controls communicates using wireless communication.

16. Optionally, a DUPMasterDevice of claim (1) and the SDUPHardwares controlled by it communicates using wired communication.

17. Preferably, a file system of claim (1) writing to mass memories all the dirty file system buffer cache buffers assigned to a user and removing the association between the user and all the buffers assigned to the user before the state corresponding to the user is allowed to change; Preferably, the SDUPHardware device driver sends a command to the SDUPHardware to change state when the computer is ready for state change; Where SDUPHardware device driver is the software module that controls the SDUPHardware.

18. Preferably, all SDUPHardware of claim (1) attached to a computer and storage devices attached to the computer changing to the same state corresponding to a user at the same time.

19. A SDUPHardware of claim (1) that need not synchronize state changes for a user with other SDUPHardware changing state as soon as it receives a command from a computer to change state.

20. Preferably, a user using a DUPMasterDevice of claim (1) or a configuration software or another device for configuring one or more lists for each user, where each list contains SDUPHardwares that need to synchronize state changes as claimed in (18) for the user.

21. Preferably, a user using a DUPMasterDevice of claim (1) or a configuration software or another device for configuring another list of SDUPHardwares for each list of SDUPHardwares of claim (20), which must send synchronization requests for the synchronized state change of the list of claim (20) corresponding to a user. Preferably, the list of SDUPHardwares that need to send the SDUPHardware synchronization requests for state change of a list of claim (20) is a subset of that list.

22. A SDUPHardware that is a member of a list of claim (21) sending a SDUPHardware synchronization request to the DUPMasterDevice that sent the master command for changing the state of that user when the computer to which it is connected sends a computer command to the SDUPHardware for changing state.

23. Preferably, a DUPMasterDevice configuring a timeout for receiving the SDUPHardware synchronization requests of claim (22), when a DUPManualAction that need synchronization is received. A DUPMasterDevice discarding SDUPHardware synchronization requests of claim (22) that exceed the timeout.

24. A DUPMasterDevice updating the state corresponding to a user if SDUPHardware synchronization requests of claim (22) are received from all SDUPHardwares in a list of claim (21) before timeout of claim (23).

25. A DUPMasterDevice using a master confirmation to communicate the state change for the list of claim (20).

26. Preferably, a confirmation message of claim (25) containing user/state pairs and a list of SDUPHardwares for each pair; The SDUPHardwares which are not in a list ignoring the corresponding user/state pair.

27. Preferably, the master confirmation of claim (25) is a broadcast or multicast message.

28. If there are more than one SDUPHardwares attached to a computer as claimed in (18), preferably only one SDUPHardware interrupting the computer for a given user when an authenticated master command for the user is received.

29. Optionally, though not recommended, synchronization of claim (18) for state change for a user can be achieved by a SDUPHardware sending a SDUPHardware synchronization request of claim (22) to a hardware different from the DUPMasterDevice or to a DUPMasterDevice different from the one that sent master command to change the state corresponding to that user.

30. Optionally, SDUPHardware of claim (18) being configured to send master confirmation of claim (25).

31. Preferably, only one DUPMasterDevice of claim (1) controlling the state corresponding a given user for a given SDUPHardware at any given time. Preferably, only that DUPMasterDevice sending master confirmations of claim (25) for that user to that SDUPHardware.

32. Optionally, if more than one DUPMasterDevices of claim (1) are controlling state corresponding to a user for a SDUPHardware, such DUPMasterDevices communicating with each other to synchronize state changes for that user and to send master confirmations of claim (25) for that user.

33. Where only file systems implement access protection, writing of dirty buffers of claim (1) not being required;

34. Preferably, the SDUPHardware device driver of claim (1) or disk/array controller firmware of claim (1) or both being able to detect the state of the SDUPHardware corresponding a user.

35. The SDUPHardware device driver of claim (1) detecting the state of the SDUPHardware of claim (1) corresponding to a user by polling the SDUPHardware, or when the SDUPHardware interrupts the computer on which the SDUPHardware device driver is executing; The interrupt may be a PCI interrupt.

36. The disk/array controller firmware of claim (34) detecting the state of the SDUPHardware of claim (1) corresponding to a user by polling the SDUPHardware state or when the SDUPHardware of claim (1) creates an interrupt detectable by the firmware.

37. The storage “software” components of claim (1) which are configured by configuration software of claim (1), identifying the state of the SDUPHardware of claim (1) corresponding to a user either by polling the SDUPHardware or by getting the state from the SDUPHardware device driver of claim (1) or by getting the state from another module; The storage “software” components being all storage components of claim (1) which run on the computer connected to the SDUPHardware.

38. Preferably, the file systems of claim (1) using a timeout before the buffers in a buffer cache are assigned to the user for whom the file system removed all associations between the user and the buffers that were assigned to him as claimed in (1); Preferably, this timeout being reset if the SDUPHardware creates an interrupt when the state corresponding to that user changes as claimed in (35).

39. Optionally, the file system of claim (1) not assigning buffers in the buffer cache to a user for whom the file system removed all associations between the user and the buffers that were assigned to him as claimed in (1), until an interrupt of claim (35) is received.

40. If the DUPMasterDevice uses a timeout of claim (23) for a user for synchronizing SDUPHardware state changes, the timeout of claim (38) used by the file systems should be larger than the timeout of claim (23).

41. The timeout of claim (38) being sufficient for the state change of claim (19).

42. Optionally, the timeout of claim (23) is not required and the SDUPHardware synchronization requests are not timed out.

43. A method as claimed in (1), a user having access to portions of a mass memory or memories. The portions of mass memories to which each user has access is not mutually exclusive. The portions of mass memories to which a user has access and the type of access is written to a portion of the mass memory to which only privileged users have access. The area of the mass memory where this configuration is stored is protected by the SDUPHardware.

44. The configuration software of claim (1) allowing a user or a privileged user to configure portions or areas of a mass memory or mass memories to which the user has access, to enable or disable read and/or write access for each configured portion for the user, and to associate the access restrictions to the portions of a mass memory or mass memories to a state of the SDUPHardware of claim (1) corresponding to the user; Preferably, only a user is allowed to configure access restrictions for himself or herself within the portion of mass memory or mass memories to which he or she has access.

45. Optionally, the configuration of claim (44) is such that by default all access is disabled for a user to portions of mass memory and when a portion of mass memory to which the user was granted access is configured for read and/or write access and the access is associated to a SDUPHardware state corresponding to the user, the access to that portion of mass memory gets enabled for the user while the SDUPHardware is in that state; or the configuration is such that by default all access is enabled for a user to portions of mass memory to which the user has access and when a portion of mass memory is configured to disable read and/or write access and the disabled access is associated to a SDUPHardware state corresponding to the user, the access to that portion of mass memory gets disabled for the user while the SDUPHardware is in that state.

46. Preferably, the configuration of claim (44) corresponding to a user, is written to a predefined area of the mass memory or mass memories selected on the basis of the user identifier and write to this area is enabled for the user only on one or more states of SDUPHardware corresponding to the user. Preferably, no other user, including privileged users have write or read access to this area of the mass memory.

47. Preferably, the configuration software of claim (44) allowing users to see which portions of a mass memory or mass memories each file or directory is mapped to; Preferably, the portions or areas shown by the configuration software for a directory include portions of mass memory or mass memories used by subdirectories and all the files in the directory and subdirectories.

48. The portions of mass memory or memories of claim (1) on which access restrictions are configured corresponding to a state of the SDUPHardware corresponding to a user, need not be mutually exclusive to portions of mass memory or memories on which access restrictions are configured corresponding to another state of the SDUPHardware corresponding to the same user.

49. The portions of mass memory or memories of claim (1) on which access restrictions are configured corresponding to a state of the SDUPHardware corresponding to a user need not be mutually exclusive to portions of mass memory or memories on which access restrictions are configured corresponding to a state of the SDUPHardware for a different user.

50. The DUPImplementer of claim (1) which is configured to check access permissions, checking whether a read or a write operation requested in each read or write request to a mass memory, is permitted as per access restrictions corresponding to the current state of the SDUPHardware corresponding to the user on whose behalf the read or write request is initiated; The storage component failing the read or write operations which violate the access restrictions. More particularly, the DUPImplementer of claim (1) verifying the portions of mass memory or mass memories configured for restricting access and the type of access restriction in the current state of the SDUPHardware of claim (1) for the corresponding user, against portions of mass memory or mass memories to be written or read as per each read or write request and failing read or write requests which are not permitted.

51. If there is no entry in the configuration corresponding to a portion of mass memory or mass memories corresponding to a state of a user, all DUPImplementers of claim (1) on a computer being configured to either block or to allow read/write requests to such portions of mass memory or mass memories while the SDUPHardware is in that state.

52. Preferably, a method as claimed in (1), the file system tagging read or write requests to mass memories with the identifier of the current user of the buffer in the file system buffer cache; If more than one user is using a buffer in the file system buffer cache, the accesses are serialized; A dirty buffer in the buffer cache is written to the mass memory before the buffer is assigned to another user; Where a dirty buffer is a buffer into which the user has written.

53. The portions or areas of claim (1) of a mass memory may be identified by using any of the following parameters such as directories and files, physical blocks, disk sectors, logical blocks, a combination of head, cylinder and sector, etc. The configuration software configuring a given parameter (such as logical block number) only on those DUPImplementers that recognize the parameter.

54. Preferably, the access restrictions of claim (1) associated with each state corresponding to a user, being independent of access restrictions associated with other states of the SDUPHardware corresponding to the same user.

55. Optionally, access restrictions of claim (1) associated with each SDUPHardware state corresponding to a user, having dependency on access restrictions associated with one or more states of the SDUPHardware corresponding to the same user.

56. Preferably, read or write commands from the computer to mass memories being tagged with the tag of claim (52) or a value derived from it;

57. Optionally, the tag of claim (52) or a value derived from it being passed to a Fibre Channel mass memory using OX_ID field in a Fibre Channel read or write command.

58. Optionally, where an array or disk controller firmware or hardware of claim (1) is a DUPImplementer and is not able to identify the user who initiated a read or write request, the array or disk controller firmware or hardware allowing a read or write request if it is permitted for any of the currently active users.

59. Preferably, computer readable registers or memory locations of claim (1) containing the states of a SDUPHardware corresponding to a user is not writable by the computer.

60. Optionally, one or more steps of claim (1) could be avoided or reordered for a SDUPHardware to change state corresponding to a user after an authenticated master command is received.

61. A method as in claim (60) where SDUPHardware changes state as soon as an authenticated master command is received.

62. A method as claimed in (1), SDUPHardware could be used by any module that implements access restriction on a computer.

63. Preferably, a SDUPHardware of claim (1) presents itself as an input/output device to a computer; More particularly, a SDUPHardware is preferably a PCI card;
Optionally, a SDUPHardware is an input/output device attached directly or indirectly to the motherboard of a computer.

64. Optionally, a SDUPHardware of claim (1) presents itself as a memory to a computer;

65. The configuration software of claim (1) consists of one or more processes or modules.

66. The method claimed in (1) being applicable to all types of mass memories such as storage arrays, JBODs, RAID storage, independent disks and internal disks of computers.

67. The method claimed in (1) being used with future technologies for mass memories.

68. Optionally, the functionality of the DUPMasterDevice of claim (1) is incorporated into a computer.
